(19) United States
(12) Patent Application Publication
(10) Pub. No.: US 2025/0329243 A1
(43) Pub. Date: Oct. 23, 2025

(54) DISPLAY DEVICE

(71) Applicant: Nippon Seiki Co., Ltd., Niigata (JP)

(72) Inventors: Shinji NISHIMURA, Niigata (JP); Shinya WATANABE, Niigata (JP)

(21) Appl. No.: 18/867,587

(22) PCT Filed: Jun. 12, 2023
(86) PCT No.: PCT/JP2023/021664

§ 371 Date: Nov. 20, 2024

(30) Foreign Application Priority Data
Jun. 20, 2022 (JP) 2022-098631

(51) Int. Cl. G08B 21/18; G08B 5/36

(52) U.S. Cl. CPC G08B 21/185; G08B 5/36

(57) ABSTRACT

Provided is a vehicular display device that makes it possible to report abnormalities even when there is an abnormality at a control unit. A display device comprises a display unit, a reporting unit that reports abnormalities at the display device when turned on, and a control unit that controls the display unit and the reporting unit. The control unit comprises: a first output terminal that outputs a high signal when an abnormality has occurred at the display device and outputs a low signal when there are no abnormalities at the display device; and a second output terminal that outputs a low signal when an abnormality has occurred at the display device and outputs a high signal when there are no abnormalities at the display device. The display device comprises: a transistor that turns the reporting unit on when the high signal has been outputted from the first output terminal; and an FET and a transistor that turn the reporting unit on when the low signal has been outputted from the second output terminal.

### TECHNICAL FIELD

The present disclosure relates to a display device.

### BACKGROUND ART

For example, a vehicle recognition device disclosed in Patent Document 1 has an alert lamp in the vicinity of a monitor and includes a control device that performs various alerts, even when the monitor is in a display unavailable state due to power off or a failure of the monitor, by controlling turning on of the alert lamp.

### PRIOR ART DOCUMENT

### Patent Document

Patent Document 1: Japanese Unexamined Patent Application Publication No. 2018-118537

### SUMMARY OF THE INVENTION

### Problems to be Solved by the Invention

With the configuration disclosed in Patent Document 1, when the control device has a failure, a notification of alert information may not be issued. The present disclosure has been made in view of the foregoing circumstance, and an object is to provide a display device capable of issuing a notification of the failure even when the control device has a failure.

### Solution to Problem

To achieve the object described above, the display device according to the present disclosure includes a display section, a notifier that issues a notification indicating a failure of the display device when the display device is turned on, and a controller that controls the display section and the notifier. The controller includes a first output terminal that outputs one of a high signal and a low signal, that is, a first signal, when a failure occurs in the display device and outputs the other of the high signal and the low signal, that is, a second signal, when a failure does not occur in the display device, and a second output terminal that outputs the second signal when a failure occurs in the display device and outputs the first signal when a failure does not occur in the display device. The display device includes a first switch that turns on the notifier when the first signal is output from the first output terminal, and a second switch that turns on the notifier when the second signal is output from the second output terminal.

### Effect of the Invention

According to the present disclosure, even when a failure occurs in a controller in a display device, a notification of the failure may be issued.

### BRIEF DESCRIPTION OF THE DRAWINGS

FIG. 1 is a circuit diagram illustrating a display device according to an embodiment of the present disclosure.

FIG. 2 is a timing chart illustrating states of various output terminals, various transistor, and a notifier according to an embodiment of the present disclosure.

FIG. 3 is a timing chart illustrating states of a constant voltage source, the various transistors, a gate voltage of an FET, and the notifier according to an embodiment of the present disclosure.

### MODE FOR CARRYING OUT THE INVENTION

A display device according to an embodiment of the present disclosure will be described with reference to the accompanying drawings. In this embodiment, the display device is mounted on vehicles including automobiles, construction machines, agricultural machines, and motorcycles.

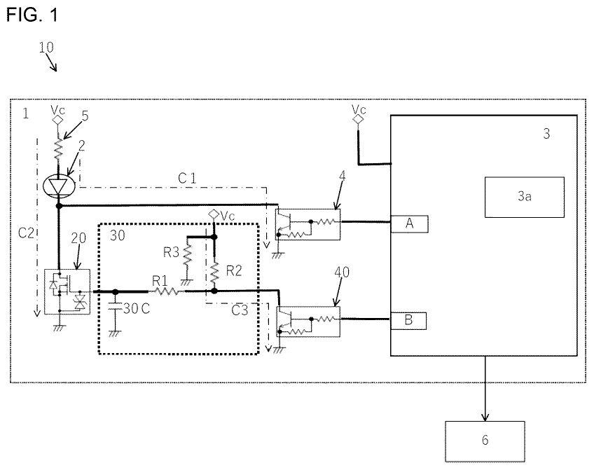

As illustrated in FIG. 1, the display device 10 includes a failure notification circuit 1 and a display section 6. The failure notification circuit 1 includes a notifier 2, a controller 3, transistors 4 and 40 including resistors, a current limiting resistor 5, a field effect transistor (PET) 20, and a delay circuit 30.

The display section 6 includes a display and/or an indicator indicating vehicle information.

The display may include a thin film transistor (TFT) type liquid crystal panel and an illumination device that illuminates the liquid crystal panel, or may include an organic electro-luminescence display (OELD).

The notifier 2 is a light emitting diode (LED) which is an example of a light source which is turned on in occurrence of a failure in the display device 10 and notifies a viewer of the occurrence of a failure by turning on the LED. The notifier 2 is disposed in a portion near the display section 6. The notifier 2 includes an anode terminal connected to a constant voltage source Vc via the current limiting resistor 5, and a cathode terminal connected to the transistor FET 20 and the transistor 4. When at least one of the FET 20 and the transistor 4 is turned on, the notifier 2 is turned on since a current flows from the constant voltage source Vc to the notifier 2.

The constant voltage source Vc starts applying a voltage when an accessory of the vehicle is turned on, and stops applying the voltage when the accessory of the vehicle is turned off. The constant voltage source Vc supplies, for example, a constant voltage of 3.3 V. The constant voltage source Vc is capable of applying a voltage to each of the notifier 2, the controller 3, and the delay circuit 30.

The current limiting resistor 5 is electrically connected between the constant voltage source Vc and the notifier 2. The current limiting resistor 5 limits an amount of current of the notifier 2 to a specified current amount, and determines a light emission luminance of the LED by the limited current.

The controller 3 is a microcomputer that controls the display section 6 and the notifier 2. The controller 3 includes a failure determiner 3a that determines whether a failure has occurred in the display section 6 or the controller 3. The controller 3 includes a first output terminal A and a second output terminal B for outputting signals opposite to each other between a high signal and a low signal.

The first output terminal A outputs a high signal when the failure determiner 3a determines that a failure has occurred in the display section 6 or the controller 3. The first output terminal A outputs a low signal when the failure determiner 3a determines that a failure has not occurred in the display section 6 or the controller 3.

The second output terminal B outputs a low signal when the failure determiner 3a determines that a failure has occurred in the display section 6 or the controller 3. The second output terminal B outputs a high signal when the failure determiner 3a determines that a failure has not occurred in the display section 6 or the controller 3. In other words, the second output terminal B always outputs a logic opposite to a logic of the first output terminal A as long as there is no high fixed failure, low fixed failure, or high impedance fixed failure in the controller 3, which will be described below.

For example, the failure determiner 3a can determine whether a failure has occurred, that is, an error of a communication with an outside of the device or an internal units, disconnection/short-circuiting of a speaker or a buzzer, a temperature abnormality. Note that the failure determiner 3a is not limited to this example as long as the failure determination can be performed on the display device 10, and for example, the failure determiner 3a may be configured not to be capable of performing a failure determination on the display section 6 but configured to be capable of performing a failure determination only on the controller 3.

The transistor 4 is a bipolar transistor, for example. The transistor 4 switches between ON and OFF in response to a signal output from the first output terminal A of the controller 3, and switches the notifier 2 between ON and OFF in response to the switching.

The transistor 4 includes a base terminal connected to the first output terminal A of the controller 3, an emitter terminal connected to the ground, and a collector terminal connected to a cathode side of the notifier 2.

The transistor 4 is turned on when a high signal is supplied from the first output terminal A, and is turned off when a low signal is supplied from the first output terminal A. When the transistor 4 is turned on, a current path C1 extending from the constant voltage source Vc to the ground via the notifier 2 and the transistor 4 becomes conductive, and a current flows from the constant voltage source Vc to the notifier 2. Accordingly, the notifier 2 is turned on (lit). On the other hand, when the transistor 4 is turned off, the current path C1 is disconnected by the transistor 4. Accordingly, the notifier 2 is turned off (lit out) when a current path C2, described below, is also disconnected.

The FET 20 is an N-channel electric field effect transistor. The FET 20 switches between ON and OFF in response to the switching between ON and OFF of the transistor 40. In particular, the FET 20 is switched off when the transistor 40 is on, and on when the transistor 40 is off. The FET 20 includes a drain terminal connected to the cathode side of the notifier 2, a source terminal connected to the ground, and a gate terminal connected to the delay circuit 30.

The FET 20 is turned on when a voltage equal to or larger than a threshold value is applied to the gate terminal of the FET 20. When the FET 20 is turned on, the drain and source terminals of the FET 20 becomes conductive. Then the current path C2 extending from the constant voltage source Vc to the ground via the notifier 2 and the FET 20 becomes conductive, and a current flows from the constant voltage source Vc to the notifier 2. Accordingly, the notifier 2 is turned on (lit). On the other hand, when the FET 20 is turned off, the current path C2 is disconnected. Accordingly, the notifier 2 is turned off (lit out) when the current path C1 described above is also disconnected.

As the FET 20, a field effect transistor is more suitable than a bipolar transistor or the like so that a charge/discharge current of the delay circuit 30 does not leak to the FET 20.

The transistor 40 is a bipolar transistor, for example. The transistor 40 switches between ON and OFF in response to a signal output from the second output terminal B of the controller 3, and switches the transistor 4 between ON and OFF in response to the switching. The transistor 40 includes a base terminal connected to the second output terminal B of the controller 3, an emitter terminal connected to the ground, and a collector terminal connected to a gate terminal of the FET 20 via the delay circuit 30.

The transistor 40 is turned on when a high signal is supplied from the second output terminal B, and is turned off when a low signal is supplied from the second output terminal B. When the transistor 40 is turned on, a current path C3 extending from the constant voltage source Vc to the ground via the transistor 40 becomes conductive. The FET 20 is turned off so that the current path C3 avoids the FET 20. On the other hand, when the transistor 40 is turned off, a voltage supplied from the constant voltage source Vc is applied to the gate terminal of the transistor 40 and the FET 20 is turned on. Accordingly, a current is supplied from the constant voltage source Vc to the notifier 2, and therefore, the notifier 2 is turned on (lit).

It can be summarized as follows. When a low signal is output from the second output terminal B, the transistor 40 is turned off, and therefore, the FET 20 is turned on. On the other hand, when a high signal is output from the second output terminal B, the transistor 40 is turned on, and therefore, the FET 20 is turned off.

The delay circuit 30 delays a timing at which the notifier 2 is turned on and a timing at which the notifier 2 is turned off corresponding to ON and OFF transitions of the transistor 40. For example, the delay circuit 30 delays a timing at which the first switching element 20 is turned on so as to prevent the notifier 2 from being erroneously turned on when power supply from the constant voltage source Vc is started or stopped. Operation of the delay circuit 30 will be described in detail hereinafter.

The delay circuit 30 includes a capacitor 30C and resistors R1 to R3.

A positive side of the capacitor 30C is connected to the gate terminal of the FET 20. A negative side of the capacitor 30C is connected to the ground. The capacitor 30C has a capacitance of, for example, 2.2 μF. The capacitor 30C gradually changes a gate voltage of the FET 20 so as to delay an ON timing and an OFF timing of the FET 20.

The resistor R1 has a first end portion connected to the positive side of the capacitor 30C and the gate terminal of the FET 20, and a second end portion connected to the resistor R2 and the collector terminal of the transistor 40. The resistor R1 is disposed to adjust a charge/discharge time of the capacitor 30C. A resistance value of the resistor R1 is, for example, 100 kΩ.

The resistor R2 has a first end portion connected to the second end portion of the resistor R1 and the collector terminal of the transistor 40, and a second end portion connected to the constant voltage source Vc. The resistor R2 is disposed to suppress a large current from flowing to the transistor 40. A resistance value of the resistor R2 is, for example, 10 kΩ. Note that the two resistors R1 and R2 may be combined into one resistor.

The resistor R3 has a first end portion connected between the constant voltage source Vc and the resistor R2 and a second end portion connected to the ground. The resistor R3 is disposed to adjust a current value for discharging electric charge accumulated in the capacitor 30C to the ground. A resistance value of the resistor R3 is, for example, 1 kΩ.

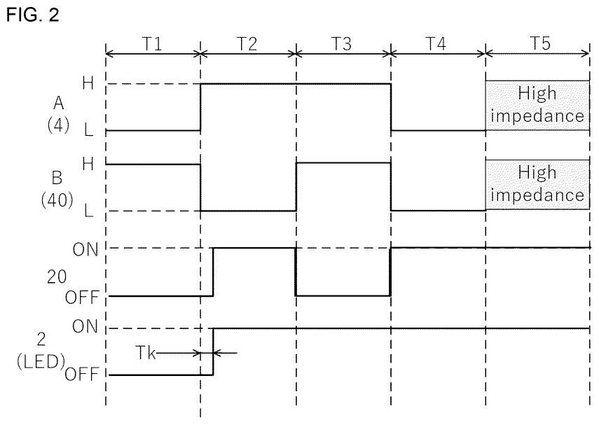

Next, operation of the failure notification circuit 1 will be described with reference to FIG. 2. In a timing chart of FIG. 2, a no-failure time T1, a failure determination time T2, a high-fixed failure time T3, a low-fixed failure time T4, and a high impedance fixed failure time T5 are set.

In the no-failure time T1, a failure does not occur in any of the display section 6 and the controller 3. In the no-failure time T1, the controller 3 outputs a low signal from the first output terminal A and a high signal from the second output terminal B. In this case, the transistor 4 is turned off, and therefore, the current path C1 is blocked. On the other hand, the transistor 40 is turned on, and therefore, the current path C3 that avoids the FET 20 becomes conductive. As a result, the notifier 2 is turned off (lit out) to indicate that the display device 10 has no failure, that is, is normal.

In the failure determination time T2, a failure which is other than the high-fixed failure, the low-fixed failure, or the high impedance fixed failure described below and which can be detected by the failure determiner 3a has occurred in the display section 6 or the controller 3. In the failure determination time T2, in the controller 3, the failure determiner 3a determines that a failure has occurred in the display section 6 or the controller 3, and a high signal is output from the first output terminal A and a low signal is output from the second output terminal B. In this case, the transistor 4 is turned on, and therefore, the current path C1 becomes conductive. Furthermore, since the transistor 40 is turned off, the current path C3 is disconnected and a gate voltage is applied from the constant voltage source Vc to the FET 20, and accordingly, the FET 20 is turned on. By this, the notifier 2 is turned on (lit) to indicate that the display device 10 has a failure. Therefore, even when the display section 6 may not notify the viewer of occurrence of a failure due to a malfunction of the display device 10, the notifier 2 can notify the viewer of the occurrence of the failure.

In the high-fixed failure time T3, the controller 3 is in a failure state such that signals output from the first output terminal A and the second output terminal B are fixed to high signals. In the high-fixed failure time T3, the controller 3 simultaneously outputs the high signals from both the first output terminal A and the second output terminal B. In this case, both the transistor 4 and the transistor 40 are turned on. When the transistor 4 is turned on, the current path C1 becomes conductive and the notifier 2 is turned on (lit). Therefore, even when a failure has occurred such that outputs of the output terminals A and B of the controller 3 are fixed to the high signals, the notifier 2 can notify the viewer of the failure.

In the low-fixed failure time T4, the controller 3 is in a failure state such that signals output from the first output terminal A and the second output terminal B are fixed to low signals. In the low-fixed failure time T4, the controller 3 simultaneously outputs low signals from both the first output terminal A and the second output terminal B. In this case, both the transistor 4 and the transistor 40 are turned off. When the transistor 40 is turned off, the current path C3 is disconnected and a voltage is applied from the constant voltage source Vc to the gate terminal of the FET 20, and accordingly, the FET 20 is turned on. By this, the current path C2 becomes conductive and the notifier 2 is turned on (lit). In this way, even when a failure has occurred such that outputs of the output terminals A and B of the controller 3 are fixed to the low signals, the notifier 2 can notify the viewer of the failure.

In the high impedance fixed failure time T5, the controller 3 is in a failure state such that the first output terminal A and the second output terminal B are fixed to a high impedance state. In the high impedance fixed failure time T5, the transistor 40 is turned off. Therefore, the current path C3 is disconnected and a voltage is applied from the constant voltage source Vc to the gate terminal of the FET 20, and accordingly, the FET 20 is turned on. By this, the current path C2 becomes conductive and the notifier 2 is turned on (lit). In this way, even when a failure has occurred such that the output terminals A and B of the controller 3 are fixed to the high impedance state, the notifier 2 can notify the viewer of the failure. Note that examples of the failure of the controller 3 include a case where the controller 3 breaks down and a case where the controller 3 can not be activated.

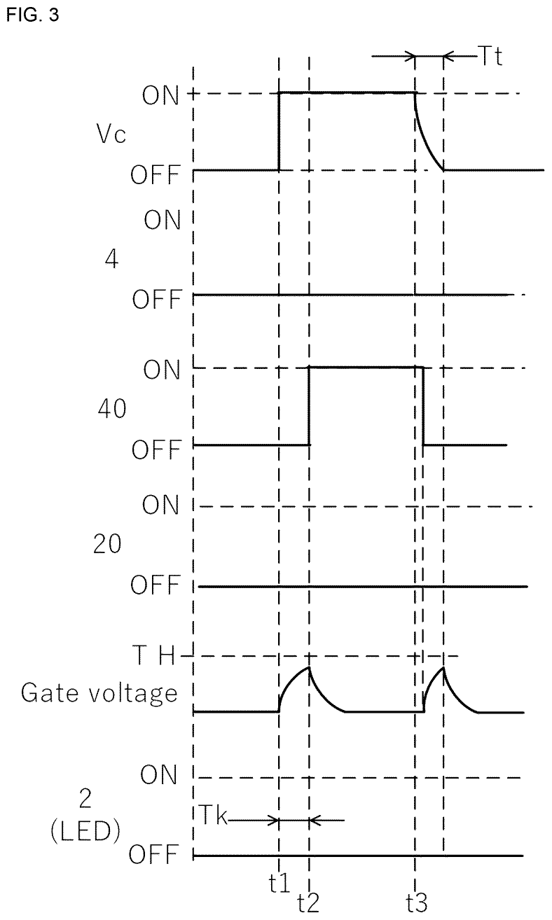

Next, operation of the delay circuit 30 will be described with reference to FIG. 3. First, operation when a power is on will be described.

When the accessory is turned on in the vehicle, the constant voltage source Vc is switched from off (voltage application stopped state) to on (voltage applied state) at a time point t1, as shown in an uppermost portion of FIG. 3. At a time point t2 at which an activation time Tk has elapsed after the time point t1, the controller 3 outputs a high signal from the second output terminal B, thereby turning on the transistor 40 as shown in a third portion from a top of FIG. 3. In the activation time Tk from the time point t1 to the time point t2, the second output terminal B is in a high impedance state or a state in which a low signal is output. In the activation time Tk, the delay circuit 30 delays a rise of a gate voltage of the FET 20 so that the gate voltage of the FET 20 does not reach a threshold value TH, as shown in a second portion from a bottom of FIG. 3. The threshold value TH is a gate voltage value at which the FET 20 is turned on. Therefore, when there is no failure even after the power is turned on, the notifier 2 can be maintained in an off state as shown in a lowermost portion of FIG. 3. Accordingly, a malfunction of the notifier 2, e.g., a case where the notifier 2 is lit for a moment, can be suppressed.

Next, operation at a time of power off will be described.

When the accessory is turned off in the vehicle, a voltage drops during a voltage drop time Tt starting from a time point t3, and therefore, the constant voltage source Vc is switched from on to off, as shown in an uppermost portion of FIG. 3. When the controller 3 enters a sleep state in the middle of the voltage drop time Tt, both the first output terminal A and the second output terminal B enter the high impedance state, and thus both the transistor 4 and the transistor 40 are turned off as illustrated in a second portion and a third portion from the top of FIG. 3. When the transistor 40 is turned off before the voltage of the constant voltage source Vc is totally drops, the voltage supplied from the constant voltage source Vc is applied to the gate terminal of the FET 20. Also in this case, the delay circuit 30 delays a rise of the gate voltage of the FET 20 so that the gate voltage of the FET 20 does not reach the threshold value TH in the voltage drop time Tt, as shown in the second portion from the bottom of FIG. 3. Therefore, when there is no failure also at a time of the power off, the notifier 2 can be maintained in an off state. Accordingly, a malfunction of the notifier 2, e.g., a case where the notifier 2 is lit for a moment, can be suppressed.

### Effects

According to the embodiment described above, the following effects are achieved. (1) The display device 10 includes the display section 6, the notifier 2 for making a notification indicating a failure of the display device 10 when turned on, and the controller 3 for controlling the display section 6 and the notifier 2. The controller 3 includes the first output terminal A that outputs a high signal, which is an example of one of a high signal and a low signal, when a failure occurs in the display device 10 and outputs a low signal, which is an example of the other of a high signal and a low signal, when no failure occurs in the display device 10, and the second output terminal B that outputs a low signal when a failure occurs in the display device 10 and outputs a high signal when no failure occurs in the display device 10. The display device 10 includes the transistor 4 which is an example of a first switch which turns on the notifier 2 when a high signal is output from the first output terminal A, and the FET 20 and the transistor 40 which are examples of the second switch which turns on the notifier 2 when a low signal is supplied from the second output terminal B.

With this configuration, even when a failure occurs in the controller 3 such that outputs of both the output terminals A and B are fixed to high signals or low signals, the notifier 2 can issue a notification of the failure.

(2) The second switch includes the FET 20 which is an example of a first switching element which turns on the notifier 2 by supplying current to the notifier 2 when being turned on in response to a voltage supplied from the constant voltage source Vc, and the transistor 40 which is an example of a second switching element which is turned on when receiving a high signal as a first signal from the second output terminal B and which is turned off when receiving a low signal as a second signal from the second output terminal B or when the second output terminal B is in the high impedance state. When the transistor 40 is turned on, the transistor 40 allows a current from the constant voltage source Vc to be supplied to the current path C3 that avoids the FET 20, and when the transistor 40 is turned off, a current is supplied from the constant voltage source Vc to the FET 20 so that the FET 20 is turned on.

According to this configuration, even when a failure occurs in the controller 3 such that outputs of both the output terminals A and B are fixed to high signals, low signals, or in the high impedance state, the notifier 2 can issue a notification of the failure with a simple configuration using the two switching elements (FET 20 and transistor 40).

(3) The display device 10 includes the delay circuit 30 which is an example of a delay section which delays a timing at which the FET 20 is turned on so that the FET 20 maintains an off state when power supply from the constant voltage source Vc is started or stopped. With this configuration, a case where the notifier 2 is instantly turned on when the power supply from the constant voltage source Vc is started or stopped can be suppressed.

(4) The FET 20 and the transistor 4, an example of the first switch, turn on the notifier 2 when receiving a high signal which is the first signal output from the first output terminal A, when a failure occurs in the controller 3 such that both the first output terminal A and the second output terminal B simultaneously output high signals. The transistor 40 which is an example of the second switch turns on the notifier 2 based on a low signal which is the second signal output from the second output terminal B or the high impedance state of the second output terminal B, when a failure occurs in the controller 3 such that both the first output terminal A and the second output terminal B simultaneously output low signals or both the first output terminal A and the second output terminal B are brought into the high impedance state.

With this configuration, even when a failure occurs in the controller 3 such that outputs of both the output terminals A and B are fixed to high signals or low signals or are in the high impedance state, the notifier 2 can issue a notification of the failure.

Note that the present disclosure is not limited to the foregoing embodiment and the drawings. Modifications (including deletion of components) may be made as appropriate without departing from the scope of the present disclosure. Examples of the modifications will be described below.

### Modifications

In the foregoing embodiment, the notifier 2 is a light source that is turned on when a failure occurs. However, instead of or in addition to this, the notifier 2 may be a speaker that emits a beep sound or a voice, or may be a vibrator that generates vibration.

In the foregoing embodiment, the delay circuit 30 may be omitted.

The FET 20 is not limited to a field effect transistor and may be a bipolar transistor. Furthermore, the transistor 4 and 40 are not limited to bipolar transistors and may be electric field effect transistors.

Although the first output terminal A outputs a high signal when a failure occurs and a low signal when a failure does not occur, and the second output terminal B outputs a low signal when a failure occurs and a high signal when a failure does not occur in the foregoing embodiment, the first output terminal A may output a low signal when a failure occurs and output a high signal when a failure does not occur, and the second output terminal B may output a high signal when a failure occurs and a low signal when a failure does not occur. In this case, as the transistors 4 and 40, a switching element of a type that turns on when a low signal is input and turns off when a high signal is input may be employed.

### DESCRIPTION OF REFERENCE NUMERALS

1 failure notification circuit
2 notifier
3 controller
3a determiner
4, 40 transistor
5 current limiting resistor
6 display section
10 display device
20 FET
30 delay circuit
30C capacitor
A first output terminal
B second output terminal
C1, C2, C3 current path
R1, R2, R3 resistor
T1 no-failure time
T2 failure determination time
T3 high-fixed failure time
T4 low-fixed failure time
T5 high impedance fixed failure time
TH threshold value
t1, t2, t3 time point
Tk activation time
Vc constant voltage source
Tt voltage drop time

1. A display device, comprising:
a display section;
a notifier that issues a notification indicating a failure of the display device when the display device is turned on; and
a controller that controls the display section and the notifier, wherein
the controller includes
a first output terminal that outputs one of a high signal and a low signal, being a first signal, when a failure occurs in the display device and outputs the other of the high signal and the low signal, being a second signal, when a failure does not occur in the display device, and
a second output terminal that outputs the second signal when a failure occurs in the display device and outputs the first signal when a failure does not occur in the display device, and the display device includes
a first switch that turns on the notifier when the first signal is output from the first output terminal, and
a second switch that turns on the notifier when the second signal is output from the second output terminal.

2. The display device according to claim 1, wherein
the second switch includes
a first switching element that turns on the notifier by supplying current to the notifier when being turned on in response to current supplied from a constant voltage source, and
a second switching element that is turned on when receiving the high signal as the first signal from the second output terminal and that is turned off when receiving the low signal as the second signal from the second output terminal or when the second output terminal is in a high impedance state, and
when the second switching element is turned on, the second switching element allows the current from the constant voltage source to be supplied to a current path that avoids the first switching element, and when the second switching element is turned off, the second switching element allows the current supplied from the constant voltage source to be supplied to the first switching element so that the first switching element is turned on.

3. The display device according to claim 2, further comprising:
a delay section that delays a timing at which the first switching element is turned on so that the first switching element maintains an off state when power supply from the constant voltage source is started or stopped.

4. The display device according to claim 1, wherein
the first switch turns on the notifier in response to a reception of the high signal as the first signal from the first output terminal when a failure occurs in the controller such that the high signal is simultaneously output from both the first output terminal and the second output terminal, and
the second switch turns on the notifier based on the low signal as the second signal supplied from the second output terminal or the high impedance state of the second output terminal when a failure occurs in the controller such that the low signal is simultaneously output from both the first output terminal and the second output terminal or both the first output terminal and the second output terminal enter a high-impedance state.
